(19) United States
(12) Patent Application Publication
(10) Pub. No.: US 2007/0045368 A1
(43) Pub. Date: Mar. 1, 2007

(54) Vehicle carrier rack utilizing a grid system for mounting accessories and load blocks

(76) Inventor: Charles C. Lavelle, North Ridgeville, OH (US)

Correspondence Address: H. W. Bergendahl and Associates, 31988 Lake Road, Avon Lake, OH, 44012, US

(21) Appl. No.: 11/216,575

(22) Filed: Sep. 1, 2005

(51) Int. Cl. B60R 7/00; B60R 9/00; B60R 11/00

(52) U.S. Cl. 224/524; 224/533; 224/325; 224/326; 224/42.38

(57) ABSTRACT

This invention provides an improved carrier rack for motorized vehicles such as all terrain vehicles (ATV). The rack provides a flat surface and includes a grid system of threaded anchor points for attachment of load blocks. Elongated fasteners with hand knobs thread into the anchor points, which provides a means for tightly securing a plurality of accessories and cargo types with or without straps, rope or hooks. The rack further includes mounting brackets with elongated slots to permit attachment to a variety of existing racks.

### CROSS-REFERENCE TO RELATED APPLICATIONS

Not Applicable

### STATEMENT REGARDING FEDERALLY SPONSORED RESEARCH

Not Applicable

### REFERENCE TO SEQUENTIAL LISTING, TABLE OR COMPUTER PROGRAM

Not Applicable

### BACKGROUND OF THE INVENTION

1. Field of the Invention

This invention relates generally to the field of vehicle mounted luggage and carrier storage racks. More particularly, the present invention relates to an all terrain vehicle (ATV) carrier rack attachment that can be quickly installed and configured to secure a variety of cargo types.

2. Description of the Related Art

Motorized vehicles, such as ATVs are versatile vehicles with a wide variety of applications, both commercial and recreational. Many vehicles incorporate carrying racks made of tubular frames, which can be used in conjunction with cords or straps to secure cargo.

The curved surface of the rack tubing along with the significant vertical and lateral movements associated with traversing off-road terrain allows loads to shift when secured with cords, straps and hooks.

Prior art contains references to rack extensions mounted to existing racks such as U.S. Pat. No. 6,502,728 issued to Savant and Patent Application Publication number US 2002/0070255. Such rack extensions, even with vertical walls, will still require cargo to be secured with cords or straps.

Other prior art such as Patent Application Publication Number US 2004/0164112 using the receiver as an attachment point to the vehicle still require straps or cords to be used with the accessory rack to attach items.

Other inventions have been disclosed for devices that secure specific items to a vehicle such as U.S. Pat. No. 5,642,844 (tree stand), U.S. Pat. No. 6,086,031 (gun and beverage support) and Patent Application Publication No. US2005/0023313 (Ladder) however these are limited to securing certain individual items therefore a different device is needed for each item to be secured.

There is a need for a mounting system, which is more secure and versatile than existing racks and affords the user easy removal and installation of a variety of accessories.

### BRIEF SUMMARY OF THE INVENTION

The present invention provides an improved carrier rack, which can easily be attached to an existing vehicle luggage or cargo rack, and provides improved versatility and more secure attachment of tools, accessories, work supplies or cargo.

The relatively stiff, roughly planar horizontal surface provided has a grid system of threaded holes into which threaded fasteners can be inserted without tools to couple load blocks or to securely attach items.

The load blocks will rotate and slide to various locations between the threaded holes to accommodate various size and shape cargo such as a gas can, chain saw or cooler. The threaded holes also provide attachment points to secure accessories such as winch mounts, toolboxes or backrests.

The rack is easily installed using U-shaped fasteners, which securely attach this rack to an existing tubular frame rack.

### BRIEF DESCRIPTION OF THE SEVERAL VIEWS OF THE DRAWINGS

FIG. 1. Shows the carrier rack from a top view attached to an ATV rack

FIG. 2. Shows the carrier rack from a side view

FIG. 3. Show the load blocks as attached to the carrier rack

FIG. 4. Shows accessory attachment to the carrier rack

### DETAILED DESCRIPTION OF THE INVENTION

Vehicle luggage and carrier racks are generally fabricated from steel tubing attached to the vehicle. Ropes, straps or cords with hooks are generally used to attach items to the rack for transport.

Due to the curved tubes and rough terrain traversed during off road travel, loads will shift and slide on racks. Similar racks are used on automobiles, trucks, motorcycles and all terrain vehicles (ATV).

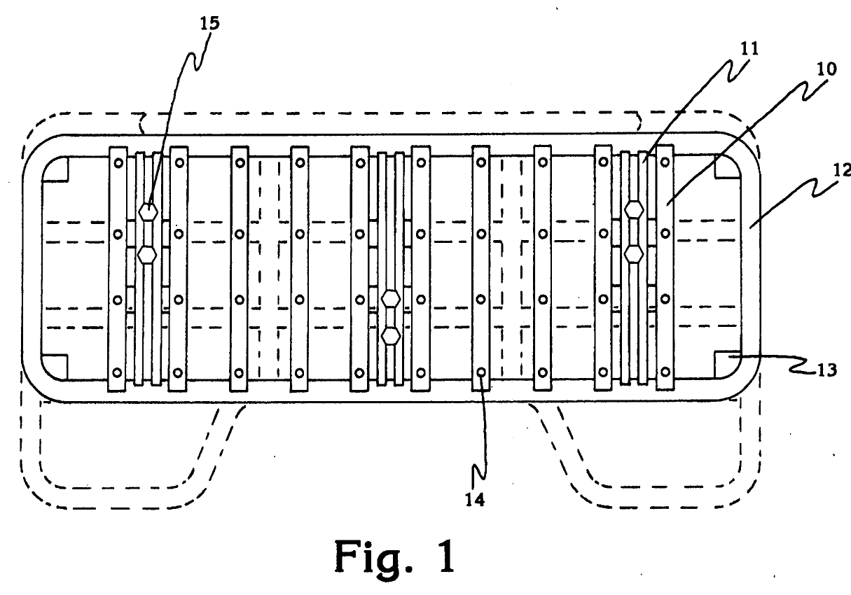

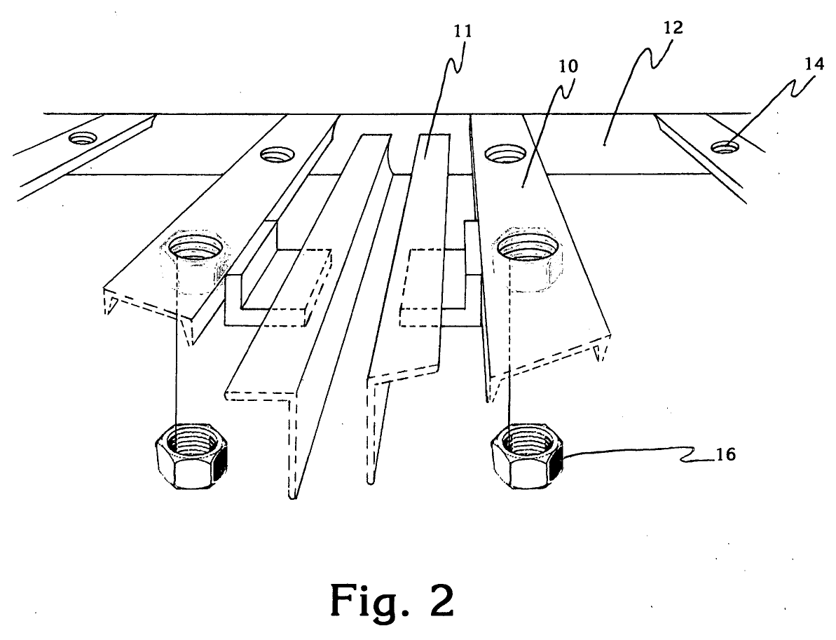

FIG. 1 shows the carrier rack with a grid system for mounting accessories and load blocks. In the preferred embodiment, the support rails (10) are made of inverted steel channel members to provide a uniform, generally planar mounting surface. The support rails (10) can also be fabricated from other materials including aluminum. The number of rails varies according to the size of the carrier rack. A coating or engraving may be applied to provide a non-slip surface and various coatings can be used for corrosion resistance and aesthetics. Mounting brackets (11) are provided to ensure at least two attachment points to the vehicle directly or with U-shaped fasteners (15) to an existing tubular rack as shown in the preferred embodiment. Support rails (10) are in welded communication with the mounting brackets (11) in the preferred embodiment. Other means of securing are available. The preferred embodiment also comprises a tubular perimeter frame (12). This frame may be omitted for certain applications. In the preferred embodiment steel wire is welded to the perimeter frame (12) to form a plurality of tie down loops (13) to provide additional attachment points for tie down methods including cords, hooks and rope. The support rails (10) have threaded holes (14) in a grid pattern with a nut (16) in welded communication with the underside as shown in FIG. 2. In alternate embodiments the thickness of the support rails (10) and number of threads may eliminate the nut (16). U-shaped fasteners (15) are attached to the underside of the mounting brackets (11) creating a secure connection to an existing rack which remains below the horizontal mounting surface of the cargo rack.

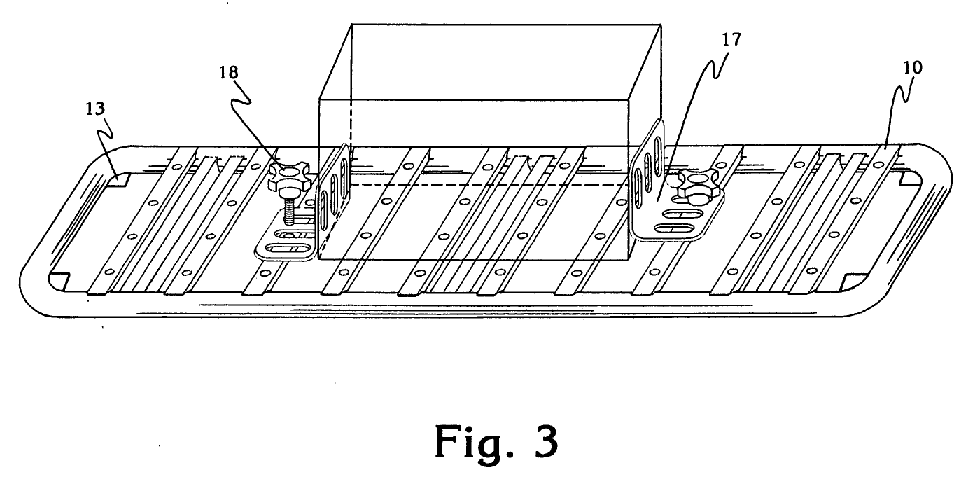

The mounting brackets (11) have elongated slots to permit adjusting the U-shaped fastener (15) location for a variety of existing vehicle racks. FIG. 3 shows the load block (17) attachment to support rails (10) using a threaded fastener (18). A variety of fasteners are available with the preferred embodiment using a hand knob device, which can be installed without tools. The load block (17) has an elongated slot to allow it to be slid closer to the material being secured or pivoted in a radial manner around the fastener to reach all areas on the rack. Multiple load blocks (17) in a plurality of sizes and shapes can be used to secure cargo of various sizes and shapes.

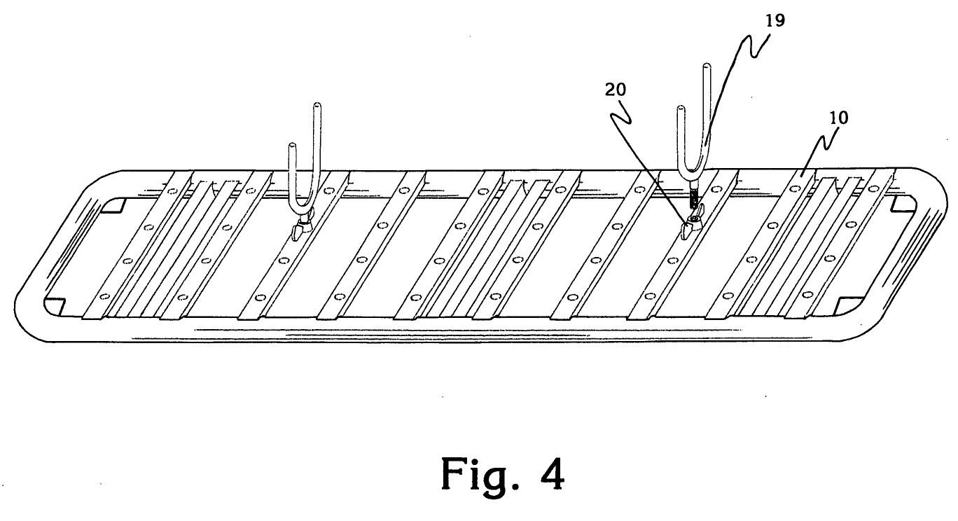

The attachment of accessories to the support rails (10) is provided by passing a threaded fastener through a mounting hole in the accessory. The preferred embodiment shown in FIG. 4 is a gun rack accessory (19), which may be directly mounted. Locknuts (20) can be used for additional support. A variety of accessories can be secured to the rack including but not limited to; a fishing pole holder, a backrest or a winch.

This invention also contemplates various size and shape carrier racks to be used on a variety of locations on different vehicles.

Even though only preferred embodiments and selected modifications thereof, have been disclosed and described other embodiments and modifications of the invention are possible within the scope of the appended claims.

What is claimed is:

1. A carrier rack for use on a motorized vehicle comprising:
(a) a plurality of interconnected, flattened rails each containing a plurality of threaded holes spaced to create a grid pattern
(b) a plurality of mounting bracket members in welded communication with said flattened rails with slots in said mounting bracket members
(c) means for joining said mounting bracket members to said vehicle.

2. The rack of claim 1 wherein said means for joining comprises a plurality of clamping brackets and elongated fasteners for securing said rack to existing tubular racks previously attached to a vehicle.

3. The rack of claim 1, further including a plurality of load blocks having elongated slots and elongated fasteners which pass through said load blocks and thread into said holes in said flattened rails.

4. The rack of claim 1 further including elongated threaded fasteners which pass through penetrations in a plurality of accessories and thread into said holes in said flattened rails.

5. The rack of claim 1 further including a frame attached to said flattened rails and defining the perimeter of said flattened rails and having a plurality of penetrations for cargo support attachment points.

6. A method of securing cargo to a vehicle rack comprising the steps of:
(a) providing a carrier rack having a plurality of flattened rails having threaded holes spaced in a grid pattern
(b) providing a plurality of load blocks with elongated slots on said rack
(c) providing elongated fasteners with threads matching threads in said holes
(d) placing cargo on said rack between said load blocks
(e) insert said fasteners through slots in load blocks and into said threaded holes in said flattened rails to secure said cargo to said rack.

7. A method of securing accessories to a vehicle cargo rack comprising the steps of:
(a) providing a cargo rack having a plurality of flattened rails having threaded holes spaced in a grid pattern
(b) providing accessories with a mounting penetration
(c) providing elongated threaded fasteners with threads matching the threads in said holes
(d) insert said fasteners through said accessory mounting penetration into said threaded holes in said flattened rail to secure said accessory to said rack.

8. A method of securing accessories to a vehicle cargo rack comprising the steps of:
(a) providing a cargo rack having a plurality of flattened rails having threaded holes spaced in a grid pattern
(b) providing accessories with a threaded fastener attached
(c) inserting threaded fastener into said threaded holes to secure said accessory to said rack.
